(19) United States
(12) Patent Application Publication
(10) Pub. No.: US 2013/0220782 A1
(43) Pub. Date: Aug. 29, 2013

(54) TAP CHANGER AND VACUUM SWITCHING TUBE FOR SUCH A TAP CHANGER

(71) Applicants: Dieter Dohnal, Lappersdorf (DE); Klaus Hoepfl, Maxhuette-Haidhof (DE); Christian Pircher, Lappersdorf (DE); Silke Wrede, Zeitlarn (DE)

(72) Inventors: Dieter Dohnal, Lappersdorf (DE); Klaus Hoepfl, Maxhuette-Haidhof (DE); Christian Pircher, Lappersdorf (DE); Silke Wrede, Zeitlarn (DE)

(21) Appl. No.: 13/811,757

(22) PCT Filed: Sep. 2, 2011
(86) PCT No.: PCT/EP2011/004433

§ 371 Date: Feb. 18, 2013

(30) Foreign Application Priority Data
Sep. 17, 2010 (DE) 10 2010 045 901.1

(51) Int. Cl. H01H 9/00

(52) U.S. Cl. CPC H01H 9/0038
USPC 200/16 R

(57) ABSTRACT

A tap changer for uninterrupted switching over between winding taps of a tapped transformer has two load branches each for a respective phase to be switched. Each load branch has a vacuum switching contact acting as main contact and parallel thereto at least one series connection of a switch-over resistance and a respective further vacuum switching contact. The two load branches are connected with a common load shunt or connectable by mechanical switching elements. Two respective vacuum switching contacts of each load branch are constructionally combined to form a single vacuum switching tube with two separate movable contacts actuatable independently of one another and a common fixed contact. The common fixed contact is connected with the common load shunt or connectable mechanical switching contacts.

The present invention relates to a tap changer with vacuum-tube switches for switching between winding taps of a tapped transformer. The invention further relates to a novel vacuum-tube switch for such a tap changer.

A tap changer is known from DE 20 21 575 that has in total four vacuum switching tubes per phase. Provided in each of the two load branches are a respective vacuum switching tube as a main contact and a respective further vacuum switching tube, in series connection with a switch-over resistance, as resistance contact. In the case of uninterrupted load changeover from the previous winding tap n to a new, pre-selected winding tap n+1 initially the main contact of the side being switched off is opened and thereupon the resistance contact of the side taking is over is closed so that an equalizing current limited by the switch-over resistances flows between the two taps n and n+1. After the previously closed resistance contact of the side switching off has opened, the main contact of the side taking over then closes so that the entire load current is conducted from the new winding tap n+1 to the load shunt; the changeover is concluded.

In DE 10 2009 048 813, which is not prior published, a further tap changer is described in which additionally further mechanical switching elements are provided between the electrical connection of the two vacuum switching tubes of each load branch and the load shunt.

The known tap changers require four separate vacuum switching tubes per phase. At the outset, the requirement for a large amount of space for these vacuum switching tubes is itself, as well as the associated actuating mechanism, disadvantageous. In addition such known constructions are relative expensive due to the high component outlay.

It is an object of the invention to provide a tap changer that with the same functionality is more simply constructed and in which the switching elements require less space and moreover are less expensive.

In addition, it is an object of the invention to indicate a vacuum switching tube that is usable particularly advantageously for a tap changer further developed in this way.

The tap changer according to the invention is based on the general idea of combining the two vacuum switching tubes in each load branch to form a single vacuum switching tube.

Moreover, the vacuum switching tube according to the is invention is based on the general idea of combining the functionality of two constructionally identical tubes in a tap changer through the combination of a constructional form of a tube with two movable contact systems. In that case, the novel vacuum switching tube is of simple construction; in particular, it does not have any internally disposed contact compression springs or slide contacts.

Vacuum switching tubes with two contact places are already known per se. DE 3344367 relates to a vacuum switching tube with two contact pairs, which are electrically connected in series, in a single vacuum chamber, the contact pairs being actuatable simultaneously. DE 197 56 308 C1 relates to a similar vacuum switching tube with two switching paths arranged on a common axis, wherein internally disposed contact compression springs are provided. EP 0 258 614 B1 describes the combination of a vacuum switching tube and a specific electrical connection with a tap changer. In this regard, a plurality of switching paths is arranged in a vacuum chamber, which obliges a complicated construction of the vacuum switching tube with annular fixed contacts. Finally, DE 10 2006 033 422 B3 describes a further vacuum switching tube with a multiple functionality, wherein not only annular fixed contacts, but also internally disposed contact compression springs are also required here.

None of these known solutions is suitable for a tap changer according to the invention.

According to a preferred form of embodiment of the vacuum switching tube according to the invention the geometric dimensions of the two separate contact systems are adapted to the electrical specifications of the circuit on which the tap changer is based, particularly whether the separate contact system is is used as a main contact or auxiliary contact. For this purpose, for example, the diameter of the housing or also the stroke of the plunger of the respective separate contact system is selectively geometrically varied. In other words: The two separate contact systems of the common vacuum switching tube are not constructed identically, but are adapted by different geometric dimensioning to the electrical specifications of the tap changer. The general idea in accordance with the invention of the present vacuum switching tube is, as already explained, to combine the functionality of two constructionally identical tubes in a tap changer by the combination of a constructional form of a tube with two movable contact systems. As also described further above, in that case, however, the respective movable contact systems do not have to have the same electrical characteristics, since the contact systems fulfill different switching tasks within the switching sequence of the tap changer. In that case, a geometrically larger size of a contact system generally means greater dielectric spacings in the interior of the vacuum switching tube. This relationship is in that regard utilized by the present form of embodiment in particularly simple manner in that it matches the separate contact systems in their geometric form to the respective electrical boundary conditions of the circuit on which the tap changer is based.

The invention shall be explained in more detail in the following by way of example on the basis of drawings, in which:

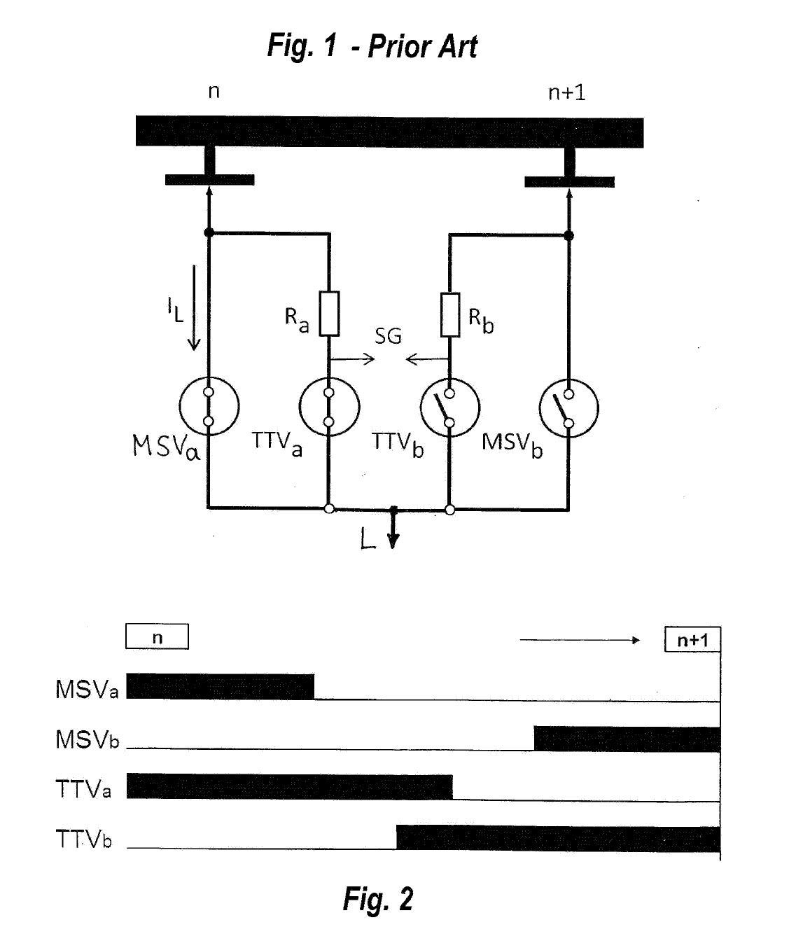

FIG. 1 shows a tap changer according to the prior art,

FIG. 2 shows a changeover sequence of such a known tap changer,

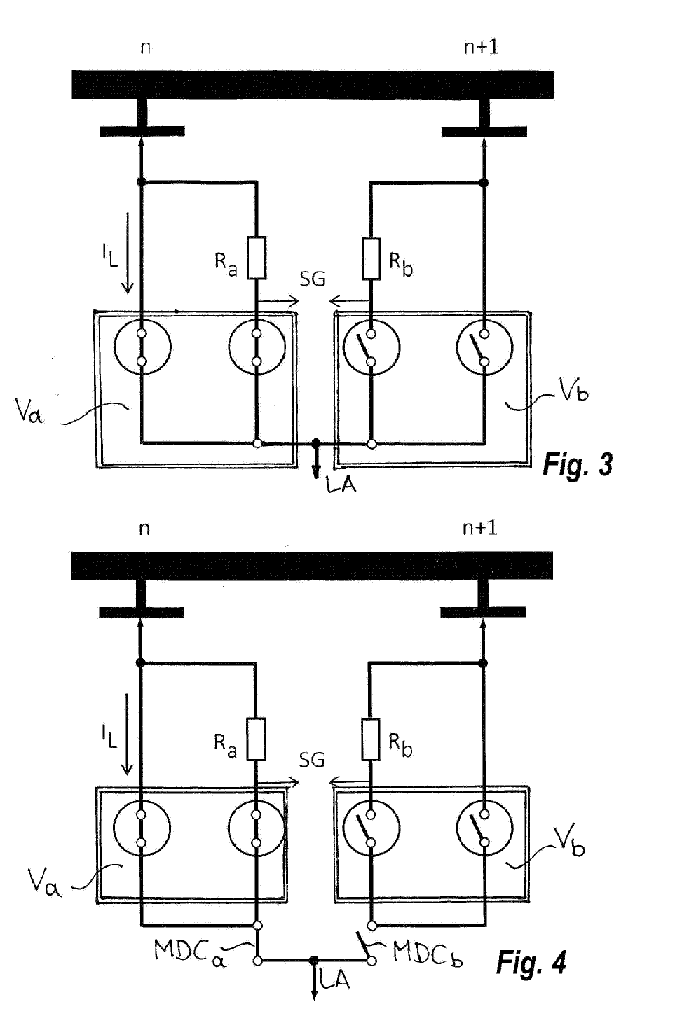

FIG. 3 shows a tap changer according to the invention with combined, single vacuum switching tube in each load branch,

FIG. 4 shows a further tap changer according to the invention with combined, single vacuum switching tube in each load branch that additionally has mechanical contacts,

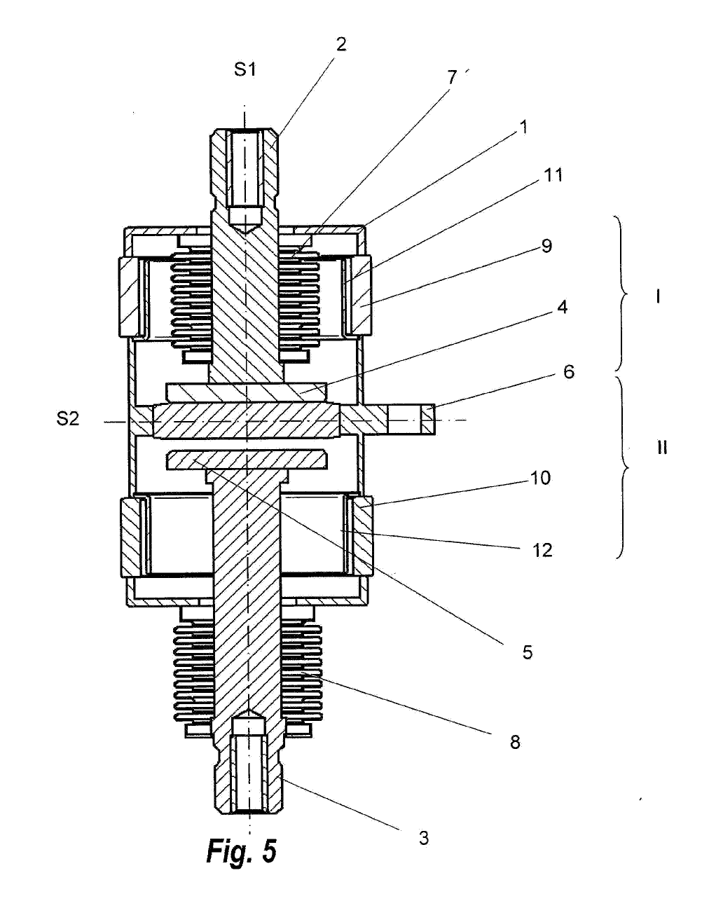

FIG. 5 shows a vacuum switching tube according to the invention and

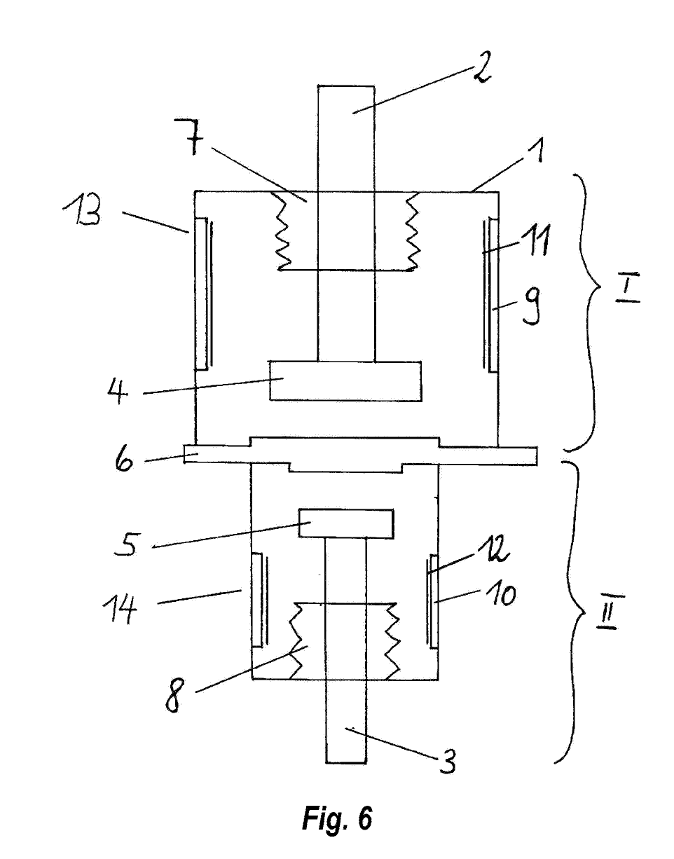

FIG. 6 shows a preferred form of embodiment of a vacuum switching tube according to the invention.

A known tap changer is shown in FIG. 1. It comprises a first load branch in which a vacuum switching tube MSVa acting as a main contact as well as a switch-over resistance Ra parallel thereto and a vacuum switching tube TTVa acting as a resistance contact are disposed. The second load branch has, in analogous manner, a vacuum switching tube MSVb as well as a further switch-over resistance Rb parallel thereto and a vacuum switching tube TTVb. The known tap changer thus has two vacuum switching cells per load branch, thus in total four vacuum switching cells per phase.

FIG. 2 shows the switching sequence of such a known tap changer in the case of switching-over from the winding tap n to the winding tap n+1. The starting position, in which the tap n is electrically connected, corresponds with the setting that is illustrated in FIG. 1, of the individual switching elements. The changeover takes place in the following steps:

MSVa opens

TTVb closes

TTVa opens

MSVb closes;

the changeover is concluded.

FIG. 3 shows a first form of embodiment of a tap changer according to the invention. Here it is schematically illustrated—by a double framing—that the previously separate, parallel arranged vacuum switching cells of one load branch are combined to form a first vacuum switching tube Va and the previously separate, parallel arranged vacuum switching cells of the other load branch are combined to form a second vacuum switching tube Vb. Combined vacuum switching tubes according to the invention are explained in more detail further below.

It is to be noted here that this combination in accordance with the invention of the functionality of previously separate vacuum switching tubes is not confined to a specific circuit; it is possible whenever two or more vacuum switching tubes are provided in a load branch.

FIG. 4 therefore shows a second form of embodiment of a tap changer according to the invention with a developed circuit. In that case, a first mechanical switch MDCa is additionally provided between the electrical connection of the first vacuum switching tube Va according to the invention (as substitute for the separate tubes MSVa and TTVa according to the prior art) and the load shunt LA. Analogously thereto a further mechanical switching element MDCb is provided between the electrical connection of the second vacuum switching tube Vb according to the invention (as substitute for the separate tubes TTVb and MSVb according to the prior art) of the other load branch and the load shunt. The two mechanical switching elements MDCa, MDCb are here constructed by way of example as circuit breakers; they serve not for commutation, but for switching free, i.e. electrical separation of the load branch not conducting the load current.

It is also possible within the scope of the invention, for example in the case of a tap changer with four separate is vacuum switching cells per phase (such circuits exist in the prior art), to replace each switching cell with a vacuum switching tube combined in accordance with the invention.

FIG. 5 shows a vacuum switching tube combined in accordance with the invention. It comprises two separate contact systems 1 and 11 that are arranged on either side of an axis s2 of symmetry in transverse direction of the vacuum switching tube. In that case, a common housing 1 enclosing the entire vacuum switching tube is provided. Provided centrally in the rotationally symmetrical longitudinal axis s1 are an upper plunger 2 and, at the opposite end, a lower plunger 3 that in the interior of the housing 1 carry movable contact members 4, 5 in known manner. The two contact members 4, 5 separately and independently of one another can be brought into connection with a common stationary contact 6 by actuation of the plunger 2 or 3. The known contact springs, which co-operate with the plungers, are, for reasons of clarity, not illustrated here. Illustrated are, however, an upper bellows 7 and a lower bellows 8 that can be constructed identically or also differently. In addition, upper and lower ceramic members 9, 10 as well as, in the interior, upper and lower attenuating screens 11, 12 are illustrated here.

FIG. 6 shows a preferred form of embodiment of a vacuum switching tube according to the invention in which the contact systems 1 and 11 are adapted to the electrical specifications specific to the tap changer by their different geometric dimensioning. The same reference numerals for identical components are used in the illustration of FIG. 6 as in FIG. 5. Since the functionalities thereof were already explained in more detail in the description with respect to FIG. 5, no more than the differences of the two forms of embodiment are discussed in the explanations with respect FIG. 6. By contract to FIG. 5, the contact systems 1 and 11 and the components present in the corresponding contact system 1 or 11 are dimensioned to be different in size and in that case the housing 1 is adapted to this geometric dimensioning in that the vacuum switching tube has a first, larger housing part 13 and a second, smaller housing part 14.

Overall, several advantages are achieved with the tap changer according to the invention: The number of vacuum switching tubes necessary is de facto halved; the space necessary for the switching elements is correspondingly smaller. Costs are similarly reduced. This is achieved by the vacuum switching tube used in accordance with the invention, which is constructed as a ‘tandem tube’ and contains two separate contact systems.

In that case the vacuum switching tube according to the invention is of simple construction; by contrast to the solutions known from the prior art it needs neither internally disposed contact compression springs nor complicated actuation mechanisms or special cage-work contact constructions, for example in annular form.

1. A tap changer for uninterrupted switching over between winding taps of a tapped transformer, wherein
two load branches are provided for each phase to be switched, each load branch comprises a vacuum switching contact acting as main contact and parallel thereto at least one series connection of a switch-over resistance and a respective further vacuum switching contact,
the two load branches are connected with a common load shunt or connectable by means of mechanical switching elements,
two respective two vacuum switching contacts of each load branch are constructionally combined to form a single vacuum switching tube with two separate movable contacts which are actuatable independently of one another, and a common fixed contact, and
the common fixed contact is connected with the common load shunt or connectable by means of mechanical switching contacts.

2. The tap changer according to claim 1, wherein exactly one series connection of a switch-over resistance and a further vacuum switching contact is provided in each load branch and that the one vacuum switching contact and the one further vacuum switching contact of each load branch are combined to form a respective vacuum switching tube.

3. A vacuum switching tube for a tap changer according to claim 1, wherein
two separate and independently actuatable movable contacts are present in mirror symmetry in a common housing,
the movable contacts are actuatable by plungers at opposite sides of the longitudinal axis of the vacuum switching tube, and
the two movable contacts are electrically connectable with a single fixed contact.

4. The vacuum switching tube according to claim 3, wherein
each of the movable contacts forms in common with an attenuating screen, which encloses it, a contact system in a separate switching chamber, and
the two contact systems and therewith the two switching chambers are disposed opposed opposite one another mirrored in mirror symmetry about an axis of symmetry perpendicularly to the rotationally symmetrical longitudinal axis of the vacuum switching tube.

5. The vacuum switching tube according to claim 3, wherein each of the two plungers is surrounded by a sealing bellows.

6. The vacuum switching tube according to claim 3, wherein the two contact systems and are dimensioned to be of geometrically different size in such a manner that these are respectively adapted to the electrical boundary conditions of the tap changer in which the vacuum switching tube is installed.
